(19) United States
(12) Patent Application Publication
(10) Pub. No.: US 2026/0195608 A1
(43) Pub. Date: Jul. 9, 2026

(54) Federated Learning applications for secure and private Machine Learning in Oil and Gas Industry

(71) Applicant: Schlumberger Technology Corporation, Sugar Land, TX (US)

(72) Inventors: Zikri Bayraktar, Cambridge, MA (US); Nikolay Baklanov, Sugar Land, TX (US); Jiacheng Wang, Sugar Land, TX (US); Muhannad Abdelaziz Abuhaikal, Cambridge, MA (US); Khaled Mouffok, Sugar Land, TX (US); Tyler Brandon, Sugar Land, TX (US); Magson Zanette, Sugar Land, TX (US)

(21) Appl. No.: 19/442,178

(22) Filed: Jan. 7, 2026

Related U.S. Application Data
(60) Provisional application No. 63/742,639, filed on Jan. 7, 2025.

(51) Int. Cl. G06N 3/098; H04L 67/12

(52) U.S. Cl. CPC G06N 3/098; H04L 67/12

(57) ABSTRACT

Techniques for training a global model for use at a host of oilfield application sites based on raw data obtained from the application sites without direct exposure of the data to the global model. The techniques include developing and distributing a global model with a predetermined set of parameter weights. The model is then locally employed at each application site by a local computer which maintains the integrity of the acquired data during performance of the oilfield application. The data is used to update the parameter weights based on real-time circumstances. Thus, the parameter weights may be transmitted to the centralized computer for updating of the global model. Further, the updated global model may continue to direct other applications and the process continued in a beneficial feedback loop manner.

### PRIORITY CLAIM/CROSS REFERENCE TO RELATED APPLICATION(S)

This Patent Document claims priority under 35 U.S.C. § 120 to U.S. App. Ser. No. 63/742,639, entitled “FEDERATED LEARNING APPLICATIONS FOR SECURE AND PRIVATE MACHINE LEARNING IN OIL AND GAS INDUSTRY”, filed on January 7, 2025 and incorporated herein by reference in its entirety.

### BACKGROUND

In recent years, the availability of data in modeling, planning and directing oilfield applications has grown tremendously. The sheer volume of historical data available to use in developing a plan for any downhole spooled conveyance application is tremendous. Once more, in addition to this ever-growing library of available data, new ways of using the data to update model learning techniques are also becoming quite prevalent.

A spooled conveyance application might include any number of passive logging or interventional application types through wells of various architectures. Regardless, where an exemplary spooled conveyance application is considered, for example, a coiled tubing logging application through a deviated well, a global model may be established. That is, the global model may be established for directing this particular application type at any number of different oilfield locations. This global model may be planned out and designed around historically available data from a relevant portion of the noted library of data. Of course, once a variety of different spooled conveyance applications such as the exemplary coiled tubing driven logging applications are run at different locations a host of new data may now be available to the library based on these newly run applications. Thus, in theory, as more and more, in this instance, coiled tubing driven logging applications are run in deviated wells based on the global model, the more updating of the model would be expected such that, over time, the model might be increasingly enhanced. Simply put, the more the global model is run, the more valuable the model may become for the application type at hand.

Unfortunately, the theory of enhancing a global model by increased use due to growing available data by increasingly employing the model often runs into a practical issue. That is, the potentially available new data from running new applications at new oilfield locations is not always available for updating of the model. This is because, while the global model may be employed for carrying out of the spooled conveyance coiled tubing logging application in the example described above, the information acquired from running this logging application may not be available for updating of the model due to various jurisdictional laws and contractual issues. For example, consider the circumstance where the applications run at the different oilfield sites by the same global model are for different customers or in different customer jurisdictions. Contractual obligations or jurisdictional laws may prevent the sharing of acquired logging information even for the purpose of updating a global model as described in the scenario above. That is, even where in lay terms this might not seem to constitute “sharing” of data, using data acquired from one customer to update a global model for the benefit of all customers may be viewed as sharing in violation of various contracts or jurisdictional laws. Therefore, as a practical matter, global model operators are often left with the only available option being to update models on a customer by customer or jurisdiction by jurisdiction basis, limiting the degree of global model enhancement that might otherwise be available.

### SUMMARY

An embodiment of the present disclosure described herein is directed at a decentralized method of training a global model at a centralized computer for use in a given application. The method includes initializing the centralized computer with the global model employing a predetermined set of parameters at a centralized location and sending a copy of the predetermined set of parameters to a plurality of local computers. In this method, each local computer of the plurality is at a discrete location and isolated from each other computer of the plurality. Employing the predetermined set of parameters to independently train a discrete model at each local computer of the plurality with private siloed data acquired by each local computer of the plurality may be undertaken. Further, aggregating the discretely trained models to update the global model at the centralized computer may ensue.

Another embodiment of the present disclosure described herein is another method where a federated technique for training a global model at a centralized computer is disclosed for use in an oilfield application. The method includes establishing the global model at the centralized computer with a predetermined set of parameter weights for the oilfield application and then distributing the parameter weights to a first local computer for running the oilfield application at a first location. This is followed by training a first local model at the first local computer with the weights based on raw data from the application at the first location. By the same token, the parameter weights are also distributed to a second local computer for running the application at a second location which is followed by training a second local model at the second local computer with the weights based on raw data from the application at the second location. Therefore, an aggregating of updated parameter weights from the trained local models for receiving at the centralized computer may take place for updating the global model.

In another embodiment of the present disclosure, a federated system for management of an oilfield application at a plurality of local application sites is disclosed. The system includes a centralized computer storing a global model with a predetermined set of parameter weights for use in the oilfield application at each of the application sites. The system also includes a plurality of local computers with a local computer at each application site to direct the oilfield application based on the global model and for training a local model based on raw data acquired from running of the oilfield application such that the trained local model may be employed to provide updated weights to the centralized computer for updating of the global model.

### BRIEF DESCRIPTION OF THE DRAWINGS

The appended figures illustrate only exemplary embodiments and are therefore not to be considered limiting of the scope of the disclosure, as the disclosure may admit to other equally effective embodiments.

FIG. 1 is a schematic overview of a federated system that includes a centralized global model for directing the same oilfield application at a plurality of different locations that is also independently updated based on application data from each location.

FIG. 2 is a schematic representation of local application data from an oilfield application being securely transmitted in a hidden manner to the centralized global model of FIG. 1 for updating thereof.

FIG. 3 is an overview depiction of an oilfield where a particular application of FIG. 1 may be run according to the centralized global model that is also updated based on hidden data from the application.

FIG. 4 is a schematic layout of an embodiment of a neural network employed to facilitate the updating of the global model based on data from the plurality of application locations that is securely hidden.

FIG. 5 is a flow-chart summarizing an embodiment of updating a centralized global model for an oilfield application with hidden data from different locations running the application.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

In the following description, numerous details are set forth to provide an understanding of the present disclosure. This includes description of the surrounding environment in which embodiments detailed herein may be utilized. Additionally, it will be understood by those skilled in the art that the embodiments described may be practiced without these and other particular details. Further, numerous variations or modifications may be employed which remain contemplated by the embodiments as specifically described.

Embodiments are described with reference to certain techniques for decentralized training of a global model from running different local applications of the same type based on the global model. For example, the embodiments shown herein illustrate running of a downhole logging application via coiled tubing running through a deviated or horizontal well. However, this is only illustrative and other types of applications of the same type at different locations may also be used for the type of feedback training of the global model taught herein.

These applications may include other types of interventional applications, passive/logging applications, hardware installation, production operations or any other oilfield application of any practical type (e.g. within wireline, slickline, coiled tubing, drilling or other domains, not limited to any particular one). Along these lines, the term “spooled conveyance” may be employed herein below as a manner of referencing any application which might fall under this general description. Regardless, so long as private siloed data from each local application computer is available for updating the global model while maintaining data isolation from each other computer, appreciable benefit may be realized.

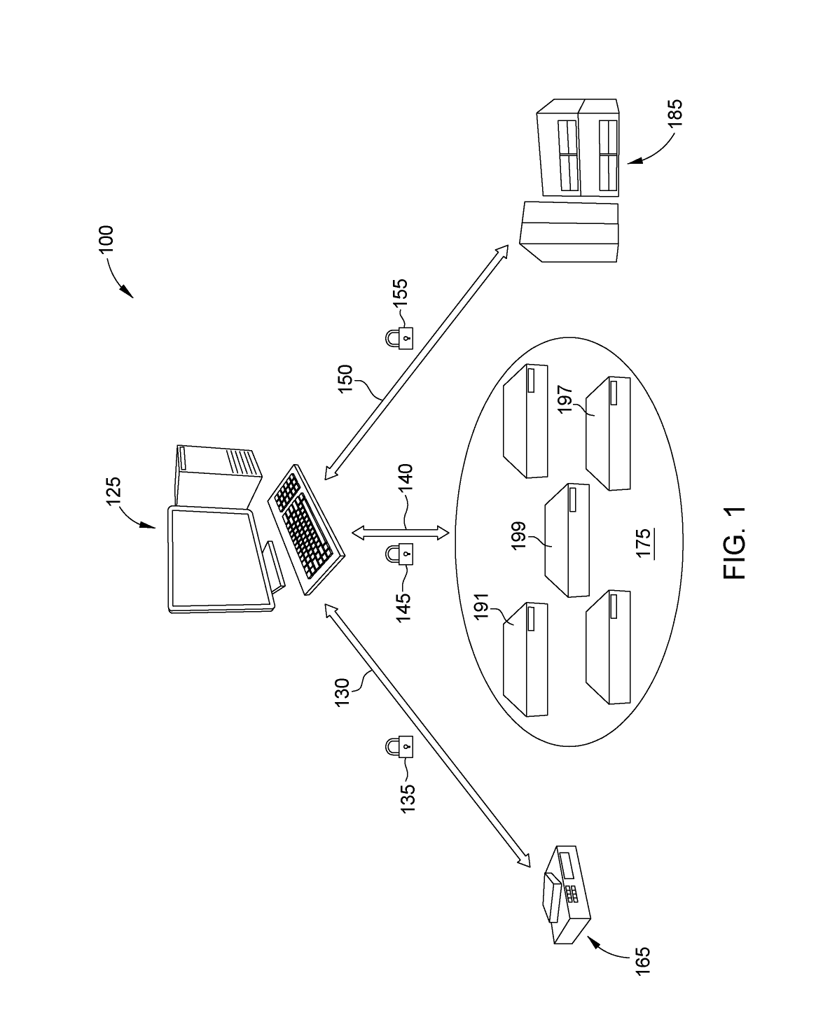

Referring specifically now to FIG. 1, a schematic overview of a federated system 100 is shown. The system 100 includes a centralized global model that is run from a centralized computer 125 to direct directing the same oilfield application at a plurality of different locations. This means that the centralized computer 125 uniquely interacts with local computer setups 165, 175, 185 at the different locations. More specifically, this interaction avoids the direct sharing of collected data from each location and computer setup 165, 175, 185 to the centralized computer 125 which runs the global model. As further security, VPN or other suitable communication locks 135, 145, 155 may also be employed to ensure firewall status at each computer setup 165, 175, 185 during local oilfield applications. Nevertheless, as illustrated, interactive communication links 130, 140, 150 between the computer setups 165, 175, 185 and the centralized computer 125 are available in spite of this security. As detailed further below, updating of model weights may instead be employed in place of raw collected data in order to update and enhance the global model. Thus, different stakeholders at different locations may participate in the same, most up to date, global model without concern over compromise to location specific raw data.

The different locations away from the centralized computer 125 may be of various site types and employ different types of computer setups 165, 175, 185 in running a local site-specific model. For example, at one location, a single computer may be employed with the application directed at a single wellsite (e.g. see 165). At another local site, a series of computers 191, 197, 199 may all be employed and in communication with one another, for example, in carrying out applications at different wells across an oilfield (e.g. see 175). In yet, another example, the computer may be individual but with data collection sufficient to warrant large scale server hardware as illustrated at 185. Of course, these are only illustrative examples. Regardless, each location may carry out a local model application that is based on the global model as described further below. Thus, each application carried out at each location shares some commonality. Therefore, even though not shared, the information acquired in running a given local application may be of value in updating the global model at the centralized computer 125. For example, each application at each location may involve running a coiled tubing or other spooled conveyance application that involves gathering of similar readings of tension, pressures, fluid compositions and so forth.

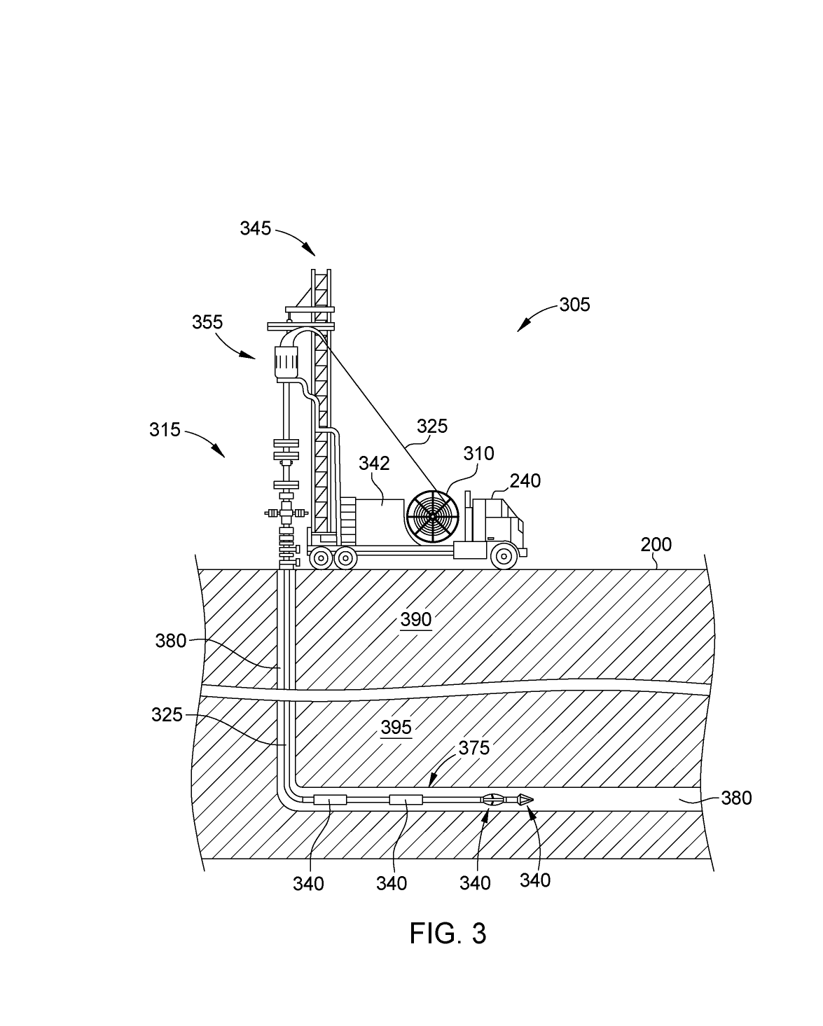

Continuing with reference to FIG. 1, each local computer setup 165, 175, 185 employs a model that is based on the global model as indicated above. Additionally, as each application is locally carried out, the local model may be trained based on the privately acquired data at the application site. So, for example, with added reference to FIG. 3, the local application site may be the illustrated oilfield 200 where an application is run as directed by a computer setup (e.g. at a control unit 342). Raw data collected during such an application may be used to train the local model carried out by the control unit 342. However, as suggested, the overall system 100 is federated in the sense that even though the data may remain siloed at the application site it may still be of benefit in also training the global model of the overall system 100 at the centralized computer 125.

Embodiments herein employ a predetermined model set of parameters or weights that are established by the centralized computer 125 with a copy distributed to each local computer setup 165, 175, 185. These parameters are used in the training of each local model. Thus, as each local model is run and trained, these parameters may be updated in an ongoing manner. For example, there may be onsite raw data readings of different types during a local application (e.g. tension, pressure, downhole viscosity). These readings may lead to a localized adjustment of these parameters or weights which are available for use in a manner that does not compromise the disclosure of the raw data. For example, retrieved or aggregated weights from three local computer setups 165, 175, 185 may be averaged and employed in updating the global model at the centralized computer 125 without ever exposing the raw data involved. That is, while the global model may be adjusted, there would be no manner of tracing any particular location specific source data that led to the adjustment. Once more, the process may be repeated in a feedback loop fashion with the updated global model sending out new parameters from the centralized computer 125 to the local setups 165, 175, 185 and the process repeating.

As part of running the federated system 100, the centralized computer 125 is also responsible for scheduling job distributions and keeping track of local computer setup 165, 175, 185 availability. Further, as suggested above, in addition to communicating the model weight parameters at the outset, the centralized computer 125 is also responsible for aggregating the returned weights and validating the locally trained models to ensure successful training location by location. Indeed, in one embodiment, validating may take place in advance of including any particular model weights for averaging in the updating of the global model.

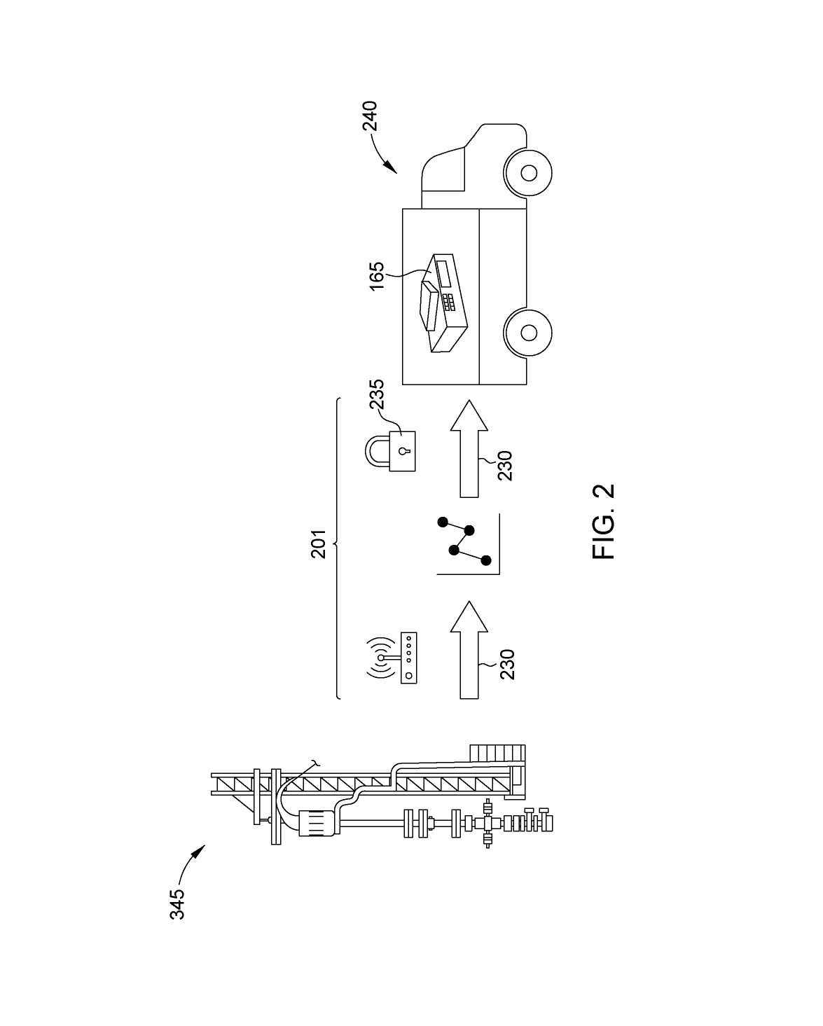

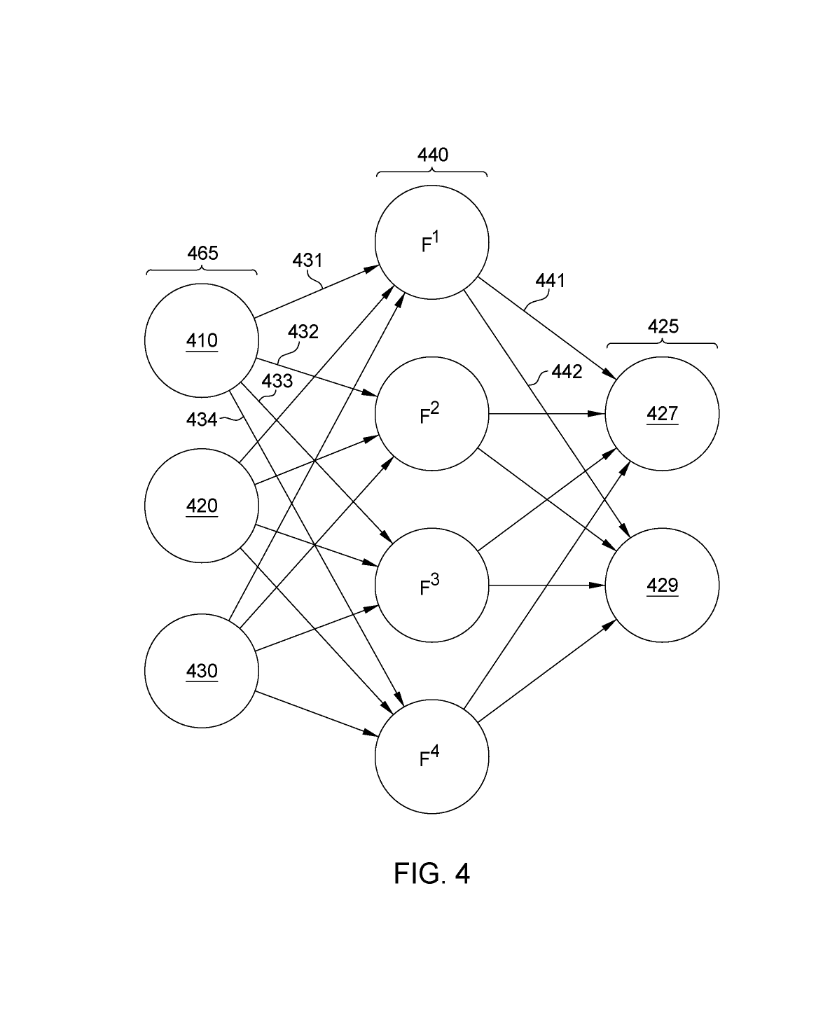

Referring now to FIG. 2, a schematic representation of local application data management as it relates to the overall system 100 of FIG. 1 is illustrated. So, for example, consider one of the local computer setups 165 of FIG. 1 that is housed at a mobile truck 240 which is positioned at an oilfield 200. The computer setup 165 may be used as described above and to direct an oilfield application through hardware 345. An exemplary illustration of the application being a coiled tubing logging application is described with reference to FIG. 3 below. However, the applications at hand may be of any practical spooled conveyance variety at the oilfield 200. Regardless, recall that the computer setup 165 is configured to obtain initial parameter weights for directing the application that may later be retrieved upon running the application and sent back to the centralized computer 125 of FIG. 1 for updating of the global model but without sharing the raw data that has been collected locally. This means that a degree of on-site processing 201 may take place to sort out the information that is available for transferring from the on-site computer setup 165. This on-site processing is described in greater detail with reference to FIG. 4. However, in summary here, this involves using protected communication links 230 to acquire and sort the raw data from the updated parameter weights, with the latter being available for transfer from the local computer setup 165 to the centralized computer 125 of FIG. 1. Again, the communication lock 235 may consist of using a virtual private network (VPN) or even dedicated hardline.

In one embodiment, cloud level computing capabilities may be utilized at edge near field locations that allow real-time or near real-time computation locally. This also may provide the added benefit of unifying and simplifying local computing resource requirements as they are deployed globally from location to location. For example, a uniformity of IT setup, network consistencies and cyber-security measures may be available to ensure secure connections can be made to the centralized computer 125 of FIG. 1, whether on the network of the centralized computer 125 provider or on servers of cloud computing providers. Regardless of the particular layout employed, the application information that is sent back to the centralized computer 125 is limited to the model weights related to the trained local model and does not include raw data. Further, the model weights may be encrypted and/or other security measures applied to prevent man in the middle attacks or any weight poisoning.

Referring now to FIG. 3, an overview depiction of an oilfield 200 is shown where a particular application of FIG. 1 may be run according to the centralized global model and system of FIG. 1 that is also updated based on hidden data from the application. For the exemplary application shown, a well 380 accommodates a toolstring 375 for a logging application, for example to acquire data in building a production profile of the well 380 running through various formation layers 390, 395. Advancement of the toolstring 375 as described above is achieved by coiled tubing 325. Surface delivery equipment 305, including a coiled tubing truck 240 with reel 310, is positioned adjacent the well 380 at the oilfield 200. With the coiled tubing 325 run through a conventional gooseneck injector 355 supported by a rig 345 over the well 380, the coiled tubing 325 and toolstring 375 with various sensors 340 may then be advanced as illustrated. Of course, any spooled conveyance application type may be pertinent to the techniques detailed herein.

As an application like the one of FIG. 3 proceeds, raw data related to the application may be acquired. For example, tension on the coiled tubing 325, particularly in light of the deviated nature of the well 380 may be of value. Other examples might include well related readings such as downhole pressure or fluid characteristics of the downhole environment. Further, this raw data may be employed in local training at the control unit 342 which might house a local computer setup 165 as shown in FIG. 2. However, as discussed above, the manner in which this data is managed is to impact parameter weights which are securely available for transfer to the global model as opposed to transfer of any raw data. This management is described in further detail with respect to FIG. 4 below.

Referring now specifically to FIG. 4, a schematic layout of an embodiment of a neural network is shown that is employed to facilitate the updating of the global model based on data from the plurality of application locations while keeping this raw data hidden. For example, with respect to the above exemplary spooled conveyance in the form of a coiled tubing logging application consider that there are various types of on-site readings 465 or “raw data”. With this example in mind, the data may be tubing tension 410, downhole pressure 420, downhole fluid characteristics 430 and a host of other data types. However, with this locally detected raw data information in hand, it is not simply transmitted to the centralized computer 125 of FIG. 1 for use. Instead, it is used locally for on-site model training as the application is carried out. This is represented by a series of hidden functions (F¹-F⁴) which are applied to model weights 431, 432, 433, 434.

Recall that at the outset, predetermined parameters are set by the global model that may be applied to each reading or value (e.g. 410, 420, 430). This means that any number of signal, cosign or other functions (F¹-F⁴), established by the centralized computer 125 of FIG. 1, may be applied to each weighted input 431-434 to ultimately provide a binary output 425 (e.g. 427 or 429). This output 425 may be useful for on-site model training. However, it is also valuable in that it constitutes a manner of adjusting the initially provided global model parameters without having to transmit any underlying raw data. In other words, the available binary output 425 (e.g. 427 or 429) may be securely sent to the centralized computer 125 of FIG. 1 for updating of the global model. In other words, a manner of encrypting the weights has been provided for securely returning the information to the centralized computer 125 without potential compromise or exposure to the underlying raw data.

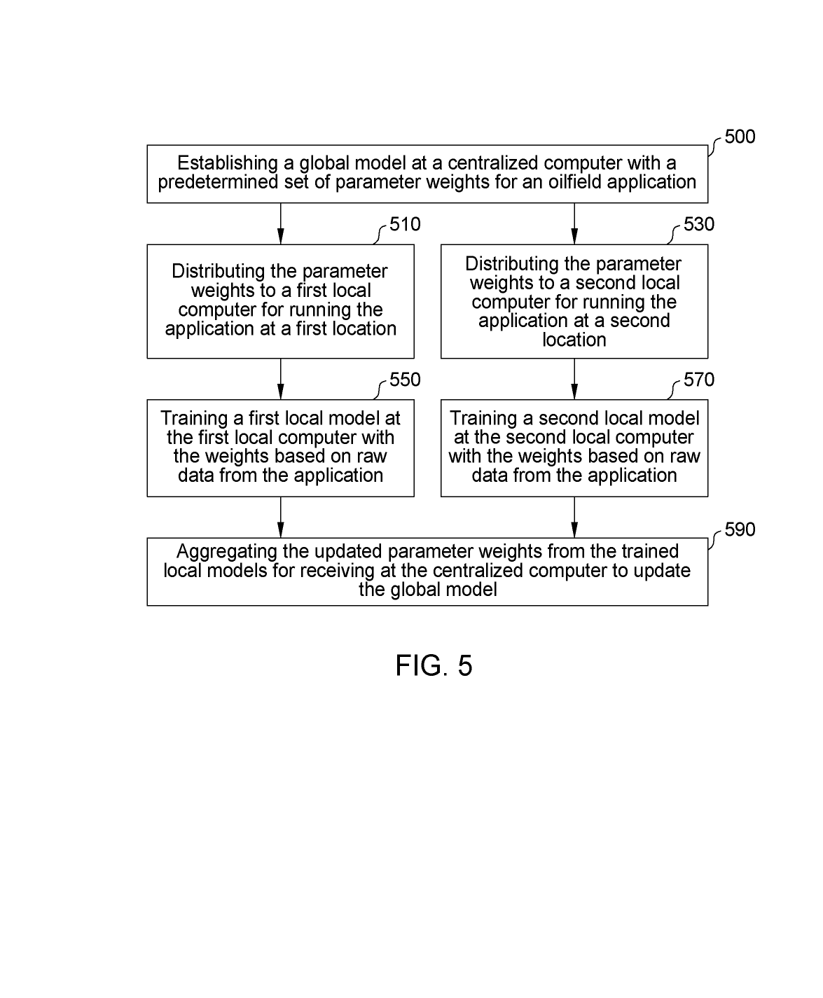

Referring now to FIG. 5, a flow-chart summarizing an embodiment of updating a centralized global model for an oilfield application with hidden data from different locations that run the application is shown. The method includes establishing a global model at a centralized computer with a predetermined set of parameter weights for the oilfield application as noted at 500. These parameter weights may be distributed to multiple local computers at multiple locations as indicated at 510 and 530. Of course, these local computers and locations may be well in excess of simply two different locations as any practical number of oilfield locations serviceable by a dedicated, on-site local computer may be in play. Regardless, as noted at 550 and 570, training of local models may take place at each location as managed by the local computer for each location as the applications are carried out. Further, even though each application and training at each location may take on a different profile as raw data is collected and the local model updated, the initial parameter weights for each application at each location is initially the same.

However, over the course of site-specific applications and training, updated parameter weights may be obtained that are unique to each site. Thus, as indicated at 590, these different weights may be aggregated together and employed in a manner that allows for updating of the global model in a manner that avoids the need to relay or compromise the locally acquired raw data.

Embodiments of enhancing a global model for any number of oilfield applications are described herein. The embodiments account for the possibility of enhancing the global model based on information acquired from local applications of the model. Once more, this is achieved in a manner that avoids compromise of direct data from the applications of the model on the local level. Instead, the techniques detailed herein allow for updating and enhancing of the global model based on information from local applications thereof but without sharing of local data for the sake of the updating. Thus, the global model may be continuously enhanced without compromise or sharing of local data.

### Additional Considerations

The preceding description has been presented with reference to presently preferred embodiments. Persons skilled in the art and technology to which these embodiments pertain will appreciate that alterations and changes in the described structures and methods of operation may be practiced without meaningfully departing from the principle, and scope of these embodiments. Regardless, the foregoing description should not be read as pertaining only to the precise structures described and shown in the accompanying drawings but rather should be read as consistent with and as support for the following claims, which are to have their fullest and fairest scope.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, “a processor,” “at least one processor,” or “one or more processors” generally refer to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refer to a single memory configured to store data and/or instructions or multiple memories configured to collectively store data and/or instructions.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. §112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A decentralized method of training a global model at a centralized computer for use in a given oilfield application, the method comprising: initializing the centralized computer with the global model employing a predetermined set of parameters at a centralized location; sending a copy of the predetermined set of parameters to a plurality of local computers, each local computer of the plurality at a discrete location and isolated from each other computer of the plurality; employing the predetermined set of parameters to independently train a discrete model at each local computer of the plurality with private siloed data acquired by each local computer of the plurality during the given oilfield application; aggregating updated parameters from the discretely trained models to update the global model at the centralized computer.

2. The decentralized method of claim 1 further comprising: distributing updated parameter weights from the updated global model to the plurality of local computers; and running the oilfield application at the discrete locations based on the updated global model.

3. The decentralized method of claim 1 further comprising confirming availability of each local computer of the plurality by the centralized computer in advance of sending the copy of the predetermined set of parameters.

4. The decentralized method of claim 1 wherein the employing of the predetermined set of parameters to independently train the discrete model at each local computer takes place in a firewalled manner during the given oilfield application.

5. The decentralized method of claim 1 wherein the oilfield application is selected from a group consisting of an interventional application and passive application.

6. The decentralized method of claim 1 wherein the aggregating of the updated parameters comprises: sending updated model weights from the discretely trained models to the centralized computer; and aggregating the updated model weights for application of the update to the global model.

7. The decentralized method of claim 6 further comprising encrypting the updated model weights from the discretely trained models in advance of the sending to the centralized computer.

8. A federated method of training a global model at a centralized computer for use in an oilfield application, the method comprising: establishing the global model at the centralized computer with a predetermined set of parameter weights for the oilfield application; distributing the parameter weights to a first local computer for running the oilfield application at a first location; training a first local model at the first local computer with the weights based on raw data from the application at the first location; distributing the parameter weights to a second local computer for running the application at a second location during the distributing of the parameter weights to the first local computer; training a second local model at the second local computer with the weights based on raw data from the application at the second location during the training of the first local model at the first local computer; and aggregating updated parameter weights from the trained local models for receiving at the centralized computer to update the global model.

9. The federated method of claim 8 further comprising: distributing updated parameter weights from the updated global model to the first and second local computers; and running the oilfield applications at the first and second locations based on the updated global model.

10. The federated method of claim 8 further comprising validating one of the first and second trained models in advance of the aggregating of the updated parameter weights.

11. The federated method of claim 8 wherein the training of the first and second local models takes place in a firewalled manner during the running of the oilfield applications.

12. The federated method of claim 8 wherein the oilfield applications are selected from a group consisting of interventional applications and passive applications.

13. The federated method of claim 8 wherein the aggregating of the updated parameter weights comprises: sending the updated model weights from the trained local models to the centralized computer; and aggregating the updated parameter weights for application of the update to the global model.

14. The federated method of claim 13 further comprising encrypting the updated model weights from the trained local models in advance of the sending to the centralized computer.

15. A federated system for management of an oilfield application at a plurality of local application sites, the system comprising: a centralized computer storing a global model with a predetermined set of parameter weights for use in the oilfield application at each of the application sites; and a plurality of local computers with a local computer at each application site to direct the oilfield application based on the global model and for training a local model based on raw data acquired from running of the oilfield application, the trained local model to provide updated weights to the centralized computer for updating of the global model.

16. The federated system of claim 15 wherein the centralized computer is configured for one of confirming each local computer availability in advance of sending the global model thereto and for validating each trained local model in advance of the updating of the global model.

17. The federated system of claim 15 wherein the updating of the global model comprises averaging of the updated weights from each of the trained local models.

18. The federated system of claim 15 wherein the acquired raw data is one of downhole equipment tension information, downhole pressure information and downhole fluid composition information.

19. The federated system of claim 15 wherein the centralized computer is further configured to send the updated global model to the plurality of local computers for updated use at each application site.

20. The federated system of claim 15 wherein each of the local model and the updated weights provided to the centralized computer are encrypted.
